(19) United States
(12) Patent Application Publication
(10) Pub. No.: US 2003/0163474 A1
(43) Pub. Date: Aug. 28, 2003

(54) System and method for indexing electronic information

(76) Inventor: William S. Herz, Hayward, CA (US)

Correspondence Address: IRELL & MANELLA LLP, 840 NEWPORT CENTER DRIVE, SUITE 400, NEWPORT BEACH, CA, 92660, US

(21) Appl. No.: 10/080,856

(22) Filed: Feb. 22, 2002

(51) Int. Cl. G06F 7/00

(52) U.S. Cl. 707/100

(57) ABSTRACT

The present invention relates to a method and system of indexing a media element. The media element to be indexed is first identified and a characterization process to be applied to the media element is selected. The characterization process is applied to the media element. The characterization process includes generating a data string for the media element, where the data string includes trait information for the media element. The media element is indexed using the data string. Various embodiments are described.

### BACKGROUND OF THE INVENTION

1. Field of the Invention

The present invention relates in general to database development, organization and presentation, and more particularly to a method and apparatus for efficiently organizing, indexing and presenting information.

2. Description of the Related Art

Advances in technology have led to the availability of a vast amount of information and also in the electronic storage of such information. Electronic storage media, such as optical or magnetic media, have excellent storage capacity and random access capability. As the state of the art evolves, processing power increases, storage capacity grows, and access time shortens while cost decreases.

These benefits, while desirable, have created a side effect—that of a bottleneck in accessing and using content based on user identification. Content is typically stored in relatively small files. To locate a desired file, a user typically has to parse through a voluminous amount of data. The organization of content is a time-intensive effort, typically requiring manual labeling and cataloging. Moreover, only the author of the media would know how the content is organized. Consequently, the location and accessing of specific content becomes a tedious experience for the user.

Accordingly, there is a need in the industry for a system and method for overcoming the aforementioned problems.

### BRIEF SUMMARY OF THE INVENTION

The present invention relates to a method and system of indexing a media element. The media element to be indexed is first identified and a characterization process to be applied to the media element is selected. The characterization process is applied to the media element. The characterization process includes generating a data string for the media element, where the data string includes trait information for the media element. The media element is indexed using the data string.

In one embodiment, a media element, such as a picture, may be characterized. The characterization process may include zooming in to a pixel cluster, identifying its color sampling scheme (e.g., with the luminance, red chrominance and blue chrominance (Y, Cr and Cb) components, and mapping the pixel values of the media element to corresponding histograms that were previously created for commonly used pixels. Various embodiments are described.

### BRIEF DESCRIPTION OF THE DRAWINGS

FIG. 1 is a system block diagram of one embodiment of a network system in which the apparatus and method of the invention may be implemented.

FIG. 2 is a system block diagram of one embodiment of a computer system which implements the embodiments of the invention.

FIG. 3 is a flow chart of one embodiment of the development process of the indexing system provided in accordance with the principles of the invention.

FIGS. 4A-B are flow charts of one embodiment of the indexing process provided in accordance with the principles of the invention.

FIG. 5 is a flow chart of one embodiment of the characterization process provided in accordance with the principles of the invention.

FIG. 6A is an example of an image to be indexed.

FIG. 6B is a flow chart of one example of the indexing process.

### DETAILED DESCRIPTION OF THE EMBODIMENTS

One aspect of the present invention relates to a system and method for identifying, characterizing, organizing, indexing, accessing and retrieving electronic information, and to provide display of the information. In one embodiment, media elements are first characterized or identified based on one or more criteria. The media elements may include text, a file of video clips, static photographs, JPEG images, audio clips, animation, graphics, any type of informational material or any combination thereof. The media elements are then organized based on the one or more criteria at a micro level. Users accessing the media elements may then retrieve the media elements based on the criteria established. In one embodiment, such identification or characterization process may proceed in response to a user instruction when the media element is received.

Definitions

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. Content refers to application programs, driver programs, utility programs, file, payload, etc., and combinations thereof, as well as graphics, informational material (articles, stock quotes, etc.) and the like, either singly or in any combination. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

System Overview

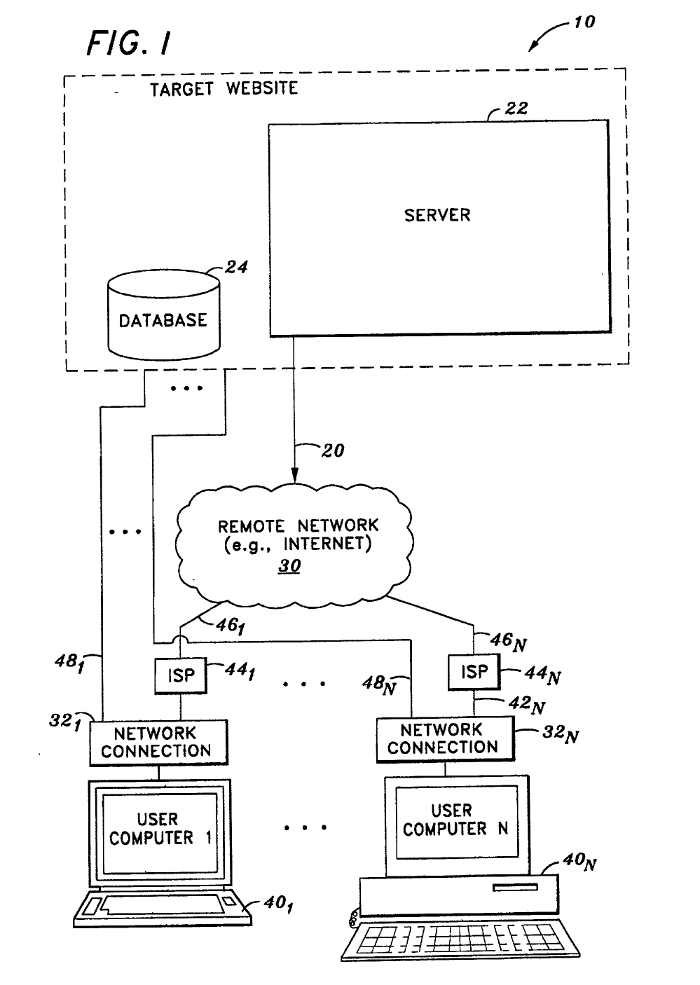

A description of an exemplary system, which incorporates embodiments of the present invention, is herein described. FIG. 1 shows a system block diagram of one embodiment of a network system 10 in which the apparatus and method of the invention is used. Referring to FIG. 1, the network system 10 comprises a target website 12 that is connected over one or more communication links 20 to a remote network 30 (e.g., a wide area network or the Internet) or a remote site (e.g., a satellite, which is not shown in FIG. 1) to one or more user computer systems 40₁-40_{N} (“40”). The target website 12 includes one or more servers 22 and one or more databases 24. In one embodiment, the server 22 includes software modules for performing the processes of the invention, as described in detail in the following sections.

It should be appreciated that the target website 12 may be comprised of only one computer system, such as server 22, or may be comprised of one or more computers. For example, a smaller number of larger computers (i.e. a few mainframe, mini, etc. computers) with a number of internal programs or processes running on the larger computers capable of establishing communication links to the user computers 40.

The remote network 30 or remote site allows the target website 12 to provide information and services to the user computers 40₁-40_{N} , using software that is stored at the target website 12. The one or more databases 24 connected to the target website computer(s) may be used to store data. Each user computer 40₁-40_{N} may be connected via network connection 46₁-46_{N} over a corresponding communication link 42₁-42_{N} such as a local carrier exchange to a respective ISP 44₁-44_{N}, through which access to the remote network 30 is made. It should further be appreciated that other computer systems may be connected to the network 30, such as Internet websites or other network portals. In an alternate embodiment, user computer 40₁-40_{N} may be connected via network connection 32₁-32_{N} over a corresponding communication link 48₁-48_{N} to the target website 12, which provides internet access and service to the user computer(s) 40. In a further embodiment, the display screen for viewing the presentation may be located on a television coupled to the network 30. For example, the end user may be a viewer of a set top box television. In this case, navigation through the presentation may be provided through the use of control buttons on a remote control unit for controlling viewing of the television, or by other means known in the art.

One aspect of the present invention relates to organizing, indexing, storing and delivering content. The software for providing such processes may occur on a computer system such as 40 or 26. Upon completion of the development process, the software may be stored in the database 24, or on the computer 40 or 26. Alternatively, the software may be stored on a machine-readable medium.

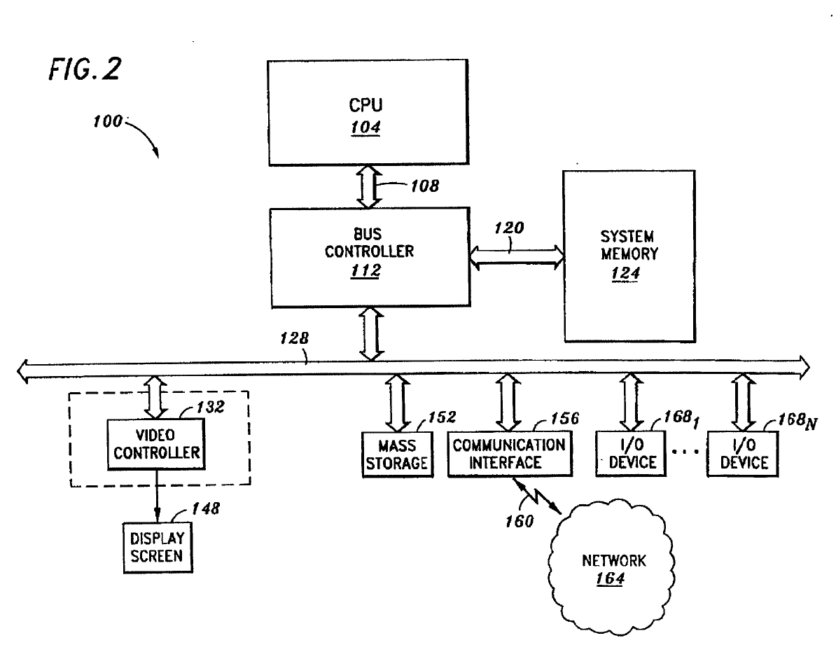

Referring to FIG. 2, the computer system 100 (representing either server 26 or user computer 40) comprises a processor or a central processing unit (CPU) 104. The illustrated CPU 104 includes an Arithmetic Logic Unit (ALU) for performing computations, a collection of registers for temporary storage of data and instructions, and a control unit for controlling operation for the system 100. In one embodiment, the CPU 104 includes any one of the x86, Pentium™, Pentium II™, and Pentium Pro™ microprocessors as marketed by Intel™ Corporation, the K-6 microprocessor as marketed by AMD™ or the 6x86MX microprocessor as marketed by Cyrix™ Corp. Further examples include the Alpha™ processor as marketed by Digital Equipment Corporation™, the 680x processor as marketed by Motorola™, or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 104. The CPU 104 is not limited to microprocessor but may take on other forms such as microcontrollers, digital signal processors, reduced instruction set computers (RISC), application specific integrated circuits, and the like. Although shown with one CPU 104, computer system 100 may alternatively include multiple processing units.

The CPU 104 is coupled to a bus controller 112 by way of a CPU bus 108. Bus controller 112 provides an interface between the CPU 104 and memory 124 via memory bus 120. Moreover, bus controller 112 provides an interface between memory 124, CPU 104 and other devices coupled to system bus 128. It should be appreciated that memory 124 may be system memory, such as synchronous dynamic random access memory (SDRAM) or may be another form of volatile memory. It should further be appreciated that memory 124 may include non-volatile memory, such as ROM or flash memory. System bus 128 may be a peripheral component interconnect (PCI) bus, Industry Standard Architecture (ISA) bus, etc. Coupled to the system bus 128 are a video controller 132, a mass storage device 152, a communication interface device 156, and one or more input/output (I/O) devices 168₁-168_{N}. The video controller 132 controls display data for displaying information on the display screen 148. In another embodiment, the video controller 132 is coupled to the CPU 104 through an Advanced Graphics Port (AGP) bus.

The mass storage device 152 includes (but is not limited to) a hard disc, floppy disc, CD-ROM, DVD-ROM, tape, high density floppy, high capacity removable media, low capacity removable media, solid state memory device, etc., and combinations thereof. The mass storage device 152 may include any other mass storage medium. The communication interface device 156 includes a network card, a modem interface, etc. for accessing network 164 via communications link 160. The I/O devices 168₁-168_{N} include a keyboard, mouse, audio/sound card, printer, and the like. The I/O devices 168₁-168ₙ may be disk drive, such as a compact disk drive, a digital disk drive, a tape drive, a zip drive, a jazz drive, a digital versatile disk (DVD) drive, a magneto-optical disk drive, a high density floppy drive, a high capacity removable media drive, a low capacity media device, and/or any combination thereof.

In accordance with the practices of persons skilled in the art of computer programming, the present invention is described below with reference to symbolic representations of operations that are performed by computer system 100, unless indicated otherwise. Such operations are sometimes referred to as being computer-executed. It will be appreciated that operations that are symbolically represented include the manipulation by CPU 104 of electrical signals representing data bits and the maintenance of data bits at memory locations in memory 124, as well as other processing of signals. The memory locations where data bits are maintained are physical locations that have particular electrical, magnetic, optical, or organic properties corresponding to the data bits.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or“machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, a DVD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed earlier, one aspect of the invention relates to a system and method for organizing, indexing and presenting information through a communication network, and to provide a seamless display of the information. The information may be stored on the hard disc of a computer, or retrieved from a website (such as target website 12). The media elements may include text, a file of video clips, static photographs, JPEG images, audio clips, animation, graphics, any type of informational material or any combination thereof.

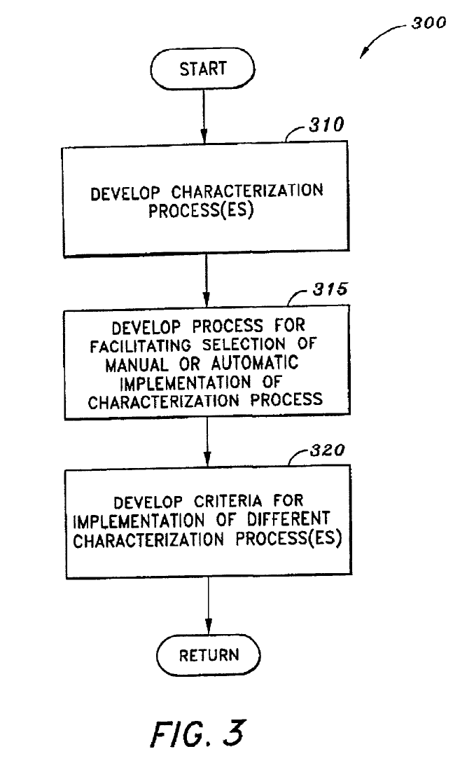

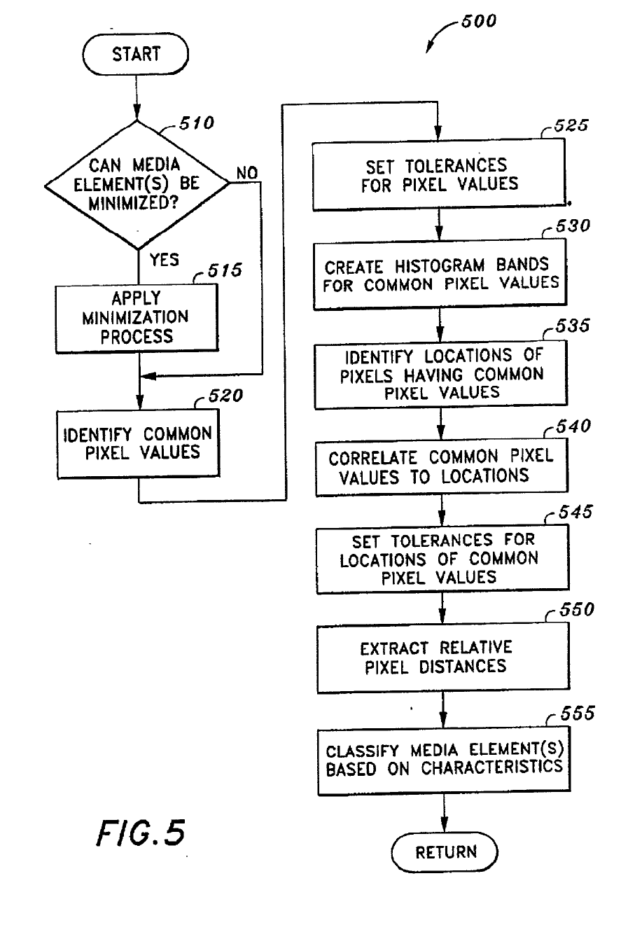

FIG. 3 is a flow chart of one embodiment of the development process 300 of the indexing system provided in accordance with the principles of the invention. In this embodiment, the development process 300 begins with the development of one or more characterization processes at block 310. As will be discussed in more detail below with reference to FIG. 5, a characterization process may culminate with the assigning of a label or identification tag to a media element, where the label can then be used to categorize, index and/or access associated media elements.

Development process 300 continues at block 315 with the development of a process for enabling the selection of either a manual or an automatic implementation of the characterization process(es) developed at block 310. In one embodiment, the selection process developed at block 315 enables a user to manually select and implement a particular characterization process. In another embodiment, the user selects a plurality of characterization processes to be implemented in a selected order. In an alternate embodiment, one or more characterization processes are selected automatically using an automatic selection process developed at block 315.

Still referring to FIG. 3, at block 320 development process 300 proceeds with the development of a process selection system which provides a set of criteria for determining which of the characterization processes developed at block 310 should be applied to a given media element. For example, assume that, in one embodiment, characterization process A and process B have been developed at block 310, where process A processes pixel-based characteristic of a media element and process B processes shape-based characteristics. Further assume that a series of media elements is provided by a user, where the media elements are pictures of variously colored dogs. In this case, applying characterization process A would enable the user to index the pictures based on the pixel-content of the dog in each picture. However, applying characterization process B would not enable the user to as effectively classify the dog pictures, given that all of the dog pictures will share similar shape-based characteristics. To this end, the process selection system developed at block 320 may enable a user to select from different characterization processes depending on the nature of the media element(s) to which they will be applied, according to one embodiment.

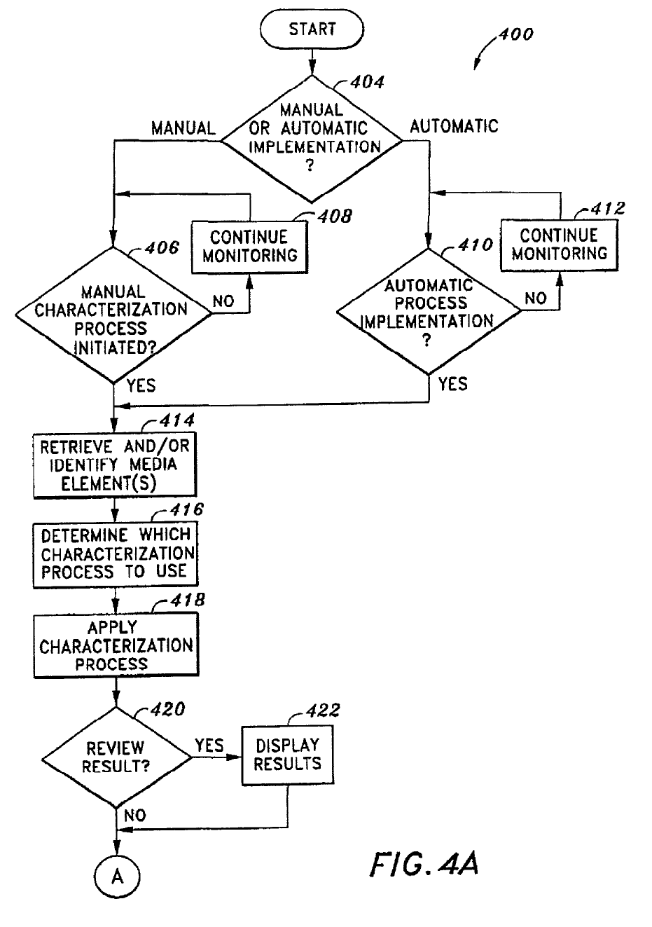

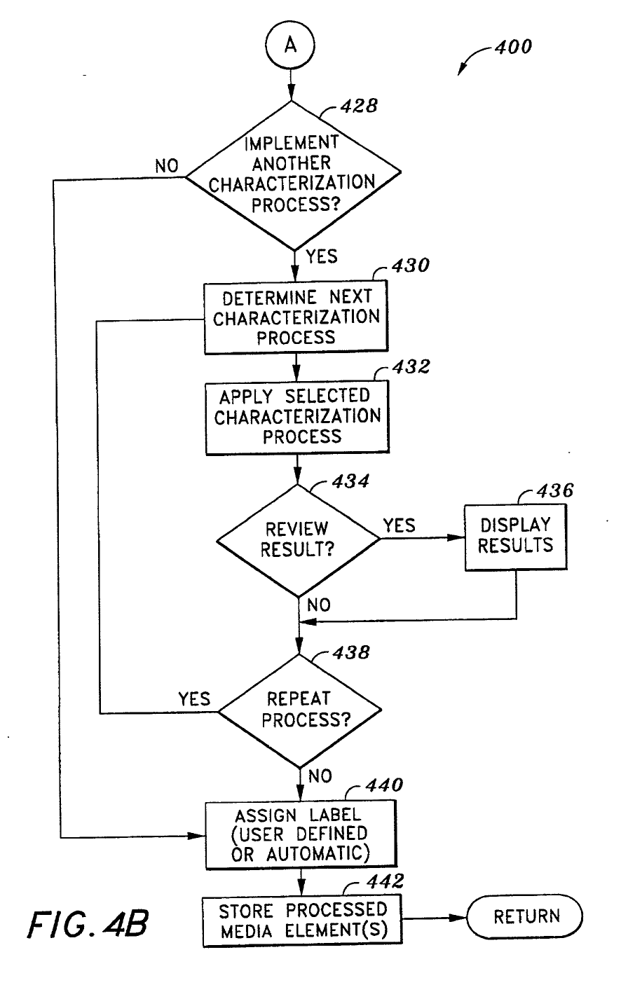

Referring now to FIG. 4A, in which a flow chart of one embodiment of the indexing process 400 is provided in accordance with the principles of the invention. At decision block 404, the process 400 determines whether the characterization process(es) will be implemented manually by a user or whether an automated selection process will be used. In one embodiment, the characterization process(es) to be implemented were developed at block 310 of FIG. 3. In another embodiment, the selection process developed at block 315 of FIG. 3 is used to make the determination of block 404. In yet another embodiment, a user indicates whether the characterization process(es) will be selected manually or automatically.

Where it is determined at block 404 that there will be manual implementation, process 400 continues with decision block 406. At this block, process 400 waits for an initiation indication to be made. Where there is no initiation, the process 400 loops through control loop 406-408. When process 400 detects a manual characterization initiation, it proceeds to block 414 where one or more media elements are retrieved.

Where there is to be automatic implementation, process 400 continues to decision block 410, where control loop 410-412 monitors whether one or more conditions for automatic implementation have been met. In one embodiment, the conditions for automatic implementation include any one or more of the following: identifying the number of the most commonly used pixel values or triads, setting thresholds of the variances of pixels which are very close in value, creating histogram bands of the most commonly occurring pixels (e.g., 5%, 2.5% or 1%), identifying the XY coordinates of the most commonly occurring pixel values or triads, correlation of the most commonly occurring pixel values or triads relative to their XY coordinates, setting thresholds of the XY coordinates to extract relative pixel distances.

Whether manual or automatic implementation is selected and initiated, the process 400 retrieves and/or identifies the media element(s) at block 414. In one embodiment, the media elements are loaded from mass storage 152 into memory 124. In another embodiment, the media element(s) are provided over network 164 and stored in memory 124. In yet another embodiment, at block 414 a location of the media element(s) is identified for subsequent accessing. The characterization process may occur while the media element is being received and/or stored or after the media element has been stored.

Continuing to refer to FIG. 4A, at block 416 process 400 determines which characterization process is to be applied to the media elements retrieved and/or identified at block 414. In one embodiment, this is carried out by the process selection system developed at block 320 of FIG. 3. In another embodiment, a user indicates which process(es) of a plurality of characterization processes will be used. It should further be appreciated that the characterization process determination of block 416 may precede or follow the operation of block 414.

Process 400 continues at block 418 with the application of the selected characterization process. Once the selected characterization process has been applied, process 400 determines whether the results of the characterization process is to be viewed by one or more users at decision block 420. If the results are to be viewed, then process 400 proceeds to block 422 where the names and rendering results are displayed. If results are not to be viewed or the operations of block 422 are completed, process 400 continues to decision block 428 of FIG. 4B, where a determination is made as to whether another characterization process is to be implemented. In one embodiment, this determination depends on the characterization process(es) identified and or selected at block 416. In another embodiment, a user is prompted at block 428 to indicate whether another characterization process is to be applied to the retrieved/identified media element(s).

If another characterization process is to be applied, process 400 continues to block 430 where a determination is made as to which characterization process is to be applied. As with block 416, the determination of block 430 may be carried out by the process selection system developed at block 320 of FIG. 3, or may be based on a user. Thereafter, the selected characterization process is applied at block 432.

Process 400 continues with decision block 434, in which a determination is made as to whether the results of the characterization process applied at block 432 are to be viewed. If so, process 400 continues to block 436 where the results are displayed. If not, decision block 438 determines whether or not the characterization process is to be applied. Control loop 430-438 continues until no further characterization processes are to be applied to the retrieved/identified media element(s).

At block 440, a label, or identification tag, is assigned to the retrieved media element(s). The label may be assigned automatically or defined by the user manually. In one embodiment, the label is a unique string of data, or fingerprint, that can be used to identify the media element and which is based on image information in the media element(s). In another embodiment, the label or identification tag serves as a pointer to the data string generated during characterization processing. In one embodiment, this label is user defined and can be used to classify media elements based on the commonality of information in their associated data strings or user descriptive label.

In the embodiment of FIG. 4B, process 400 continues with block 442 where the processed media element(s) are stored. In one embodiment, the media element(s) may have been retrieved at block 414 into memory 124, processed, and then stored on mass storage 152 at block 442. It should be appreciated, however, that other storage configurations are possible and consistent with the present disclosure.

Referring now FIG. 5, where a flow diagram of one embodiment of a characterization process 500 is provided. In this embodiment, a determination is made at block 510 as to whether the media element(s) can be minimized or compressed. For purposes of the present discussion, the characterization of an image is provided. Such an image may include a video clip, static photograph, JPEG image, animation, or other graphics. It is understood that the characterization process may be applied to other media elements, such as audio files or clips, text, any type of informational material or any combination thereof.

In one embodiment, various aspects of color may be used to characterize an image. In particular, all digital video (compressed, uncompressed, motion or still) is comprised of fundamental color components. Typical components are 8 to 10 bits and represent a color space. For example, MPEG and JPEG images are based on a 4:2:0 color sampling scheme, with three components, luminance, red chrominance and blue chrominance (Y, Cr and Cb). Printed images are based on cyan, magenta, yellow and black (C, M, Y and K). Bit map images are comprised of a red, green, blue or R, G, B triad. For example, a typical television image is comprised of approximately 350,000 RGB triads. Using compression technology, the image can be reduced to approximately 70,000 triads or less. By minimizing the pixels or triads to process, the characterization process can be accomplished with fewer processing resources since there will be fewer pixel values to process (evaluate or inspect) post-compression.

If a determination is made at block 510 that the media element(s) can be minimized, characterization process 500 applies the minimization process at block 515. The minimization or compression process may be a full or a partial compression process. An example of a partial compression process includes a Discrete Cosine Transform and quantization process. Thereafter, process 500 identifies common pixel values at block 520. In one embodiment, the pixel values identified occur within a predetermined visual area or visual space, where the predetermined area is a subset of the entire area taken up by the media element. In this embodiment, the size and orientation of this predetermined area may be a function of the characteristics being processed by the characterization process 500. By way of a non-limiting example, the predetermined area may be in the shape of a border around the edges of the media element. This may be the case where the characterization process chosen aims to classify media elements based on the type of border they have. Alternatively, the predetermined area may be an area that is roughly in the center of the media image, thereby eliminating the need to process pixels along the periphery. In another embodiment, all pixels comprising a media element are identified at block 520.

According to one embodiment, the common pixel values identified at block 520 correspond to color values. These color values may be represented as the individual color components of the pixel, or may be represented as a single color value. In one embodiment, the color components used are the Y, Cr, Cb components in the case of an MPEG or JPEG image. Alternatively, these color components may be the R, G, B triad of bit mapped images. In yet another embodiment, the color components are the C, M, Y, K values used in the printing context.

It should be appreciated that any other known measure of pixel color may also be used where color characteristics are being used to index media elements. It should further be appreciated that common pixel values other than color may be identified at block 520, such as texture, fog, etc. In addition, while the embodiment of the invention under discussion relates to images, the invention can also be used and applied to audio files, where such files include music. For example, the invention may be used to sample music at any point, and/or organize audio files based on criterion such as audio values, and type or name of songs.

Once the most common pixel values in the media element(s) are identified, the embodiment of FIG. 5 then determines, at block 525, the desired tolerances which are to be used. For example, in the embodiment where color is the pixel value being analyzed, white may be identified as a common pixel value at block 520, according to one embodiment. However, it may be desirable to include small variations from true white, which may even be undetectable to the human eye. In such a case, setting a tolerance to include off white, light gray and other white-based hues may improve the indexing process.

Process 500 continues with block 530 where histogram bands are generated for the common pixel values identified at block 520. In one embodiment, the histogram bands are based on the percentage of the whole that a particular identified pixel value represents. By way of a non-limiting example, a media element of a white dog on a black background having blue eyes may produce histogram bands showing white pixels representing 32% of the image, black pixels comprising 67% of the image, and blue pixels making up 1% of the image. In another embodiment, no histogram bands are generated and the process 500 continues to block 535.

Continuing to refer to FIG. 5, the locations of the identified common pixel values are then determined at block 535. In one embodiment, the X and Y coordinates of the pixels having the identified common values are determined. However, it should be appreciated that other measures of location may also be used.

At block 540, the common pixel values determined at block 520 are correlated to the locations determined at block 535. In one embodiment, this enables process 500 to generate a data string representing common pixel values as a function of their location, or vice versa. At block 545, tolerances are set for the locations determined at block 535. Thereafter, at block 550 information representing the relative distances between pixels having the identified common values can be generated. In other words, distances between the locations, such as orientation within the frame (determined at block 535) of the pixels having common pixel values (determined at block 520) are determined. In one embodiment, these distances represent the relative distances between pixels having different pixel values, while in another embodiment these relative distances represent distances between pixels having the same or similar pixel values.

In one embodiment, the tolerances of the pixel values set at block 525 and the tolerances of the pixel locations set at block 545 are adjusted until a desired accuracy and/or result is achieved. In one embodiment, a user manually adjusts these tolerances, while in another embodiment the tolerances are automatically adjusted based on the nature of the results. In yet another embodiment, these tolerances are adjusted based on the nature of the media element(s) to which the characterization process is applied.

Once the relative pixel distances are extracted, they can used to form a unique string of data, or fingerprint, according to one embodiment. This fingerprint can then be used to classify the media elements (block 555). In one embodiment, media elements are classified based on common information found in their fingerprints. In another embodiment, a user can also assign a name or label to as a pointer to the fingerprint, thereby indexing the media element based on its content, as represented by the fingerprint.

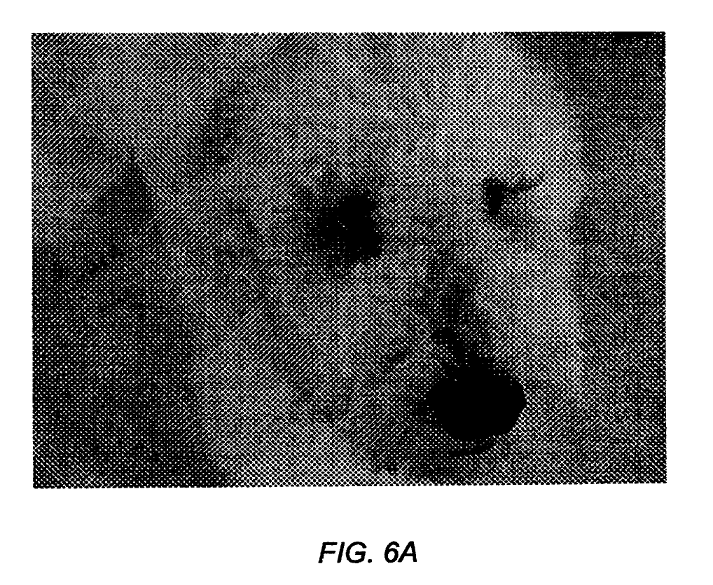

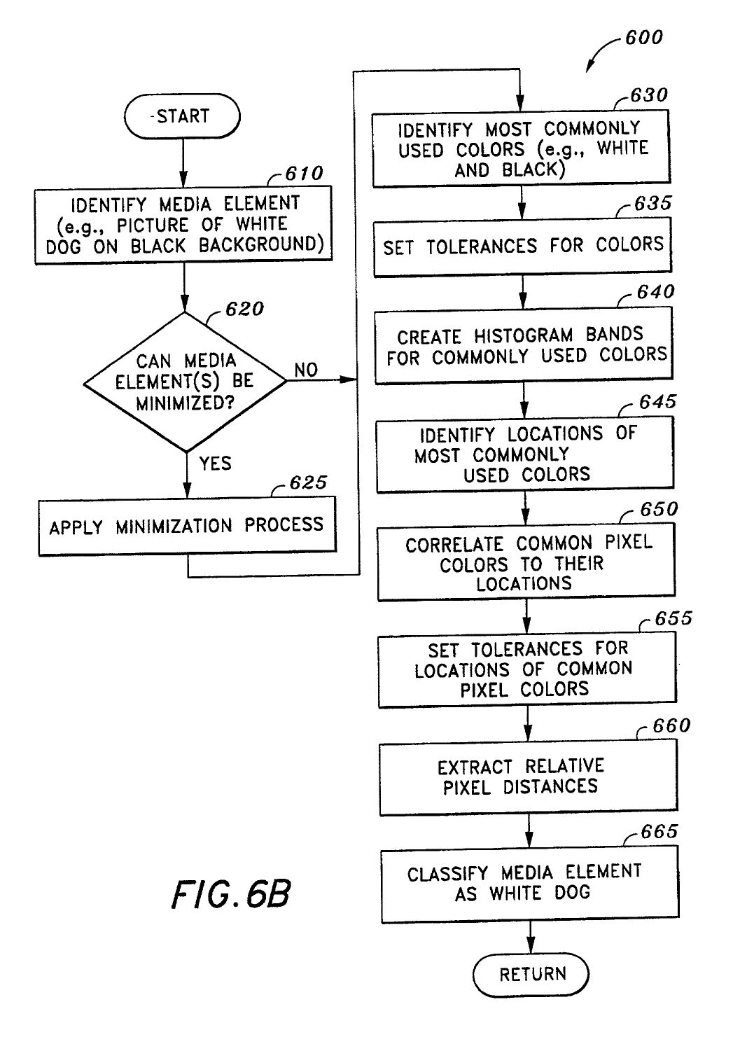

FIG. 6A is an example of an image to be indexed, while FIG. 6B is a flow chart of one example of the indexing process 600. In this embodiment, a user desires to index a picture of a dog by the color of the dog in the picture. To this end, a picture of a white dog on a black background (such as that shown in FIG. 6A) is identified for indexing at block 610. As described previously with reference to FIG. 5, indexing process 600 next determines if the picture can be minimized. If so, indexing process applies a compression process to the picture at block 625. If not, indexing process 600 continues to block 630.

At block 630 the most common colors found in the picture are identified. In this embodiment only the colors white and black are identified as being common colors. While in one embodiment all of the pixels in the picture may be analyzed, in this embodiment, only the colors of the pixels in a predetermined area are analyzed. Since the picture is to be indexed only by the pixel-content of the dog, only the pixels comprising the center portion of the picture are analyzed. As discussed previously, this reduces the number of pixels that are analyzed, thereby increasing the efficiency of the process. If, however, the dog was not more or less centered in the picture, then in another embodiment the process 600 would review all of the pixels in the picture.

At block 635 tolerances for the colors white and black are set. Depending on the desired accuracy and/or result, color tolerances may be set to further include off white, dark gray, and/or dark brown hues. Histogram bands are then generated at block 640 for white and black pixels. In another embodiment, no histogram bands are generated and the indexing process 600 proceeds to block 645.

Indexing process 600 continues with block 645 with the identification of the locations of the white and black pixels which were identified in block 630. In one embodiment these locations are represented by the X and Y coordinates along the face of the picture. However, it should be appreciated that other known methods of registering pixel locations may be used as well.

At block 650, the locations identified in block 645 are correlated to the pixel colors identified previously at block 630. In one embodiment this is done by associating the identified common color of a pixel to its X-Y coordinates.

Continuing to refer to FIG. 6, at block 655 the tolerances for the locations of the common pixel colors are set. As with the tolerances set at block 635, in one embodiment these tolerances may be adjusted until a desired accuracy and/or result is achieved. Once this is done, it is possible to extract the relative distances between the pixels having the commonly occurring colors (block 660). In one embodiment, the distances between the white pixels relative to other white pixels are extracted. In another embodiment, the relative distances between the white pixels and the black pixels are extracted. Similarly, it is also possible to extract relative distance data between black pixels.

Once the relative pixel distance data is extracted at block 660, this data can be used to create a unique string of data, which is based on the pixel color relationships in the picture and which can be used as a fingerprint, or unique identifier, for the picture. This data string can also be used to index this picture with other similar pictures (i.e., other pictures of white dogs) by using common information in the fingerprint, according to one embodiment. To this end, the picture in this embodiment is classified as a white dog at block 665 by comparing information in the data string to some reference. In one embodiment, this reference is another picture of a white dog.

If, on the other hand, there is no reference, then at block 665 the picture may be classified as a white dog by having a user assign a label to the data string as a pointer. Thereafter, future pictures having similar color relationships may be indexed under the user defined label. In this manner, the single label can be used to access all white dog pictures without having to preview each picture. In one embodiment, the user may review a list of labels, each of which corresponds to a data string, where the data string represents a media element that has been previously indexed (through an automated or manual process as described previously).

Although the present invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method of indexing a media element comprising:
identifying the media element to be indexed;
selecting a characterization process to be applied to said media element;
applying said characterization process to said media element, said characterization process to include,
generating a data string for said media element, said data string including trait information for said media element; and
indexing said media element using said data string.

2. The method of claim 1, wherein said media element is one of a video clip, static photograph, JPEG image, animation, audio clip, and text.

3. The method of claim 1, wherein identifying the media element comprises selecting the media element and loading the media element into a memory of a computer system.

4. The method of claim 3, wherein loading the media element into said memory comprises downloading said media element over a network connection.

5. The method of claim 1, further comprising determining if the media element can be compressed and, if so, compressing a data file containing said media element before applying the characterization process to said media element.

6. The method of claim 1, wherein selecting said characterization process comprises selecting said characterization process to be applied to said media element from a plurality of characterization processes based on a predetermined criteria.

7. The method of claim 1, wherein said characterization process further includes,
determining at least one common pixel value of said media element, and
determining a relationship between a first pixel and a second pixel of said media element, said first and second pixels each having said at least one common pixel value.

8. The method of claim 7, wherein determining at least one common pixel value comprises determining at least one common pixel value for said media element, and wherein said relationship between said first pixel and second pixel is based on a distance between said first and second pixels.

9. The method of claim 1, wherein applying said characterization process further comprises:
determining at least one common pixel value of said media element;
determining a first tolerance for each of said at least one common pixel value;
identifying a plurality of pixels of said media element having said at least one common pixel value;
determining pixel locations for each of said plurality of pixels;
determining a second tolerance for said pixel locations; and,
determining relative pixel distance information for said plurality of pixels.

10. The method of claim 9 where generating a data string for said media element comprises generating a data string for said media element, said data string including trait information for said media element, said trait information to be based on said at least one common pixel value and said relative pixel distance information.

11. The method of claim 9, further comprising generating a histogram band for each of said at least one common pixel value of said media element, where said histogram bands are based on a percentage of a predetermined area of said media element that said at least common pixel value represents.

12. The method of claim 9, further comprising adjusting at least one of said first and second tolerances to achieve a desired result.

13. The method of claim 1, further comprising assigning a label to said media element, and accessing said media element using said label.

14. The method of claim 13, wherein said label is used as a reference pointer to said data string.

15. The method of claim 1, wherein indexing said media element comprises comparing said data string for said media element to an additional data string, said additional data string corresponding to an additional media element, and associating the media element with the additional media element where said data string and additional data string have a common trait.

16. The method of claim 1, further comprising displaying a result of said indexing to a user.

17. The method of claim 1, wherein said characterization process is applied only to a predetermined area of said media element.

18. The method of claim 1, wherein said characterization process further includes determining at least one shape-based trait of said media element, said at least one shape-based trait to be included in said trait information of said data string.

19. The method of claim 1, further comprising retrieving said media element by reviewing a list of labels, each of said labels corresponding to a data string representing an indexed media element; and selecting said media element from said list for display.

20. A system for indexing a media element comprising:
a processor;
a display coupled to the processor;
a memory coupled to the processor, the memory containing instruction sequences to cause said processor to:
identify the media element to be indexed;
select a characterization process to be applied to said media element;
apply said characterization process to said media element, said characterization process to,
generate a data string for said media element, said data string including trait information for said media element; and
index said media element using said data string.

21. The system of claim 20, wherein said media element is one of a video clip, static photograph, JPEG image, animation, audio clip, and text.

22. The system of claim 20, wherein said instruction sequences to cause said processor to identify the media element include instruction sequences to select the media element and to load the media element into the memory.

23. The system of claim 22, wherein said media element is loaded into the memory by downloading said media element over a network connection.

24. The system of claim 20, wherein said memory further includes instruction sequences to cause said processor to determine if the media element can be compressed and, if so, to compress a data file containing said media element before applying the characterization process to said media element.

25. The system of claim 20, wherein said instruction sequences to cause said processor to select said characterization process further cause said processor to select said characterization process to be applied to said media element from a plurality of characterization processes based on a predetermined criteria.

26. The system of claim 20, wherein said characterization process is further to,
determine at least one common pixel value of said media element, and
determine a relationship between a first pixel and a second pixel of said media element, said first and second pixels each having said at least one common pixel value.

27. The system of claim 26, wherein said at least one common pixel value is at least one common pixel color for said media element, and said relationship between said first pixel and second pixel is based on a distance between said first and second pixels.

28. The system of claim 20, wherein said characterization process is further to:
determine at least one common pixel value of said media element;
determine a first tolerance for each of said at least one common pixel value;
identify a plurality of pixels of said media element having said at least one common pixel value;
determine pixel locations for each of said plurality of pixels;
determine a second tolerance for said pixel locations; and,
determine relative pixel distance information for said plurality of pixels.

29. The system of claim 28, where said characterization process is further to, generate a data string for said media element, said data string including trait information for said media element, said trait information based on said at least one common pixel value and said relative pixel distance information.

30. The system of claim 28, where said characterization process is further to, generate a histogram band for each of said at least one common pixel value of said media element, where said histogram bands are based on a percentage of a predetermined area of said media element that said at least common pixel value represents.

31. The system of claim 28, where said characterization process is further to,
adjust at least one of said first and second tolerances to achieve a desired result.

32. The system of claim 20, where said memory further includes instructions sequences to cause said processor to assign a label to said media element, and to access said media element using said label.

33. The system of claim 32, wherein said label is used as a reference pointer to said data string.

34. The system of claim 20, wherein said instruction sequences to cause said processor to index said media element further includes instructions sequences to,
compare said data string for said media element to an additional data string, said additional data string corresponding to an additional media element, and
to associate the media element with the additional media element where said data string and additional data string have a common trait.

35. The system of claim 20, wherein said characterization process is applied only to a predetermined area of said media element.

36. The system of claim 20, wherein said characterization process is further to, determine at least one shape-based trait of said media element, said at least one shape-based trait to be included in said trait information of said data string.

37. The system of claim 20, wherein said instruction sequences further cause said processor to retrieve said media element by displaying a list of labels, each of said labels corresponding to a data string representing an indexed media element; and to receive user input to select said media element from said list for display.
